(19) United States
(12) Patent Application Publication
(10) Pub. No.: US 2025/0317062 A1
(43) Pub. Date: Oct. 9, 2025

(54) TRANSFORMER-BASED VOLTAGE SINGLE STEP CONVERSION TO RAIL VOLTAGE

(71) Applicant: Cisco Technology, Inc., San Jose, CA (US)

(72) Inventors: Joel Richard Goergen, Soulsbyville, CA (US); John W. Beecroft, Camarillo, CA (US); Elizabeth Kochuparambil, Morgan Hill, CA (US)

(21) Appl. No.: 18/941,546

(22) Filed: Nov. 8, 2024

Related U.S. Application Data
(60) Provisional application No. 63/575,384, filed on Apr. 5, 2024.

(51) Int. Cl. H02M 3/335; H02M 3/00

(52) U.S. Cl. CPC H02M 3/335; H02M 3/003

(57) ABSTRACT

In one embodiment, a power delivery apparatus includes a power transmitter configured to generate a power waveform at a first voltage. The power waveform includes a series of successive on-times that are separated by an off-time. A transformer is coupled to the power transmitter, wherein the transformer is configured to receive the power waveform and perform a single step down conversion of the power waveform at the first voltage to an output waveform at a second voltage. A rectifier circuit is coupled to the transformer to receive the output waveform and produce a direct current (DC) rail voltage for use by one or more power consuming devices.

### PRIORITY CLAIM

This application claims priority to U.S. Provisional Patent Application No. 63/575,384, filed Apr. 5, 2024, entitled “Transformer-Based Voltage Single Step Conversion to Rail Voltage,” the entirety of which is incorporated herein by reference.

### TECHNICAL FIELD

The present disclosure relates to power conversion for integrated circuits.

### BACKGROUND

Power supply efficiency and the size of the components make printed circuit board (PCB) design complex. Board mounted switch mode power supplies take a significant amount of PCB space, and require a significant number of thick copper power distribution layers-at a great cost.

### BRIEF DESCRIPTION OF THE DRAWINGS

FIG. 1 is a block diagram of a power delivery apparatus using a transformer-based voltage conversion arrangement used to produce a rail voltage, according to an example embodiment.

FIG. 2A is a more detailed schematic diagram of a power delivery apparatus, according to an example embodiment.

FIG. 2B is a more detailed schematic diagram of a power delivery apparatus having a feedback loop to adjust the voltage provided by the power delivery apparatus, according to an example embodiment.

FIGS. 2C and 2D are schematic diagrams of a comparator circuit that may be used in the power delivery apparatus, according to an example embodiment.

FIG. 2E is a block diagram of an arrangement to configure a voltage trim circuit that is used in a power transmitter of the power delivery apparatus, according to an example embodiment.

FIG. 2F is a diagram depicting example DIP switch states to configure the voltage trim circuit, according to an example embodiment.

FIG. 3 is a flow diagram depicting operation of the feedback loop based on a comparison of a rail voltage with a reference voltage, according to an example embodiment.

FIG. 4 is a flow diagram depicting operation of the feedback loop at a power transmitter to adjust the voltage of a power waveform based on a feedback waveform, according to an example embodiment.

FIG. 5 is a diagram showing how a voltage of a power waveform is adjusted up or down based on a frequency of a feedback waveform, according to an example embodiment.

FIG. 6 is a schematic diagram of a single monument transformer that may be employed in the power delivery apparatus, according to an example embodiment.

FIGS. 7A-7G are diagram showing examples of transformer shapes and designs that may be used in the power delivery apparatus, according to an example embodiment.

FIGS. 8A and 8B are diagrams depicting how a rail voltage converter package, that includes the transformer and associated circuitry, may be contained in a housing and mounted to an integrated circuit or printed circuit board, according to an example embodiment.

FIG. 9 is a perspective view of a multi-layer electronic device that employs multiple instances of the power delivery apparatus, according to an example embodiment.

FIG. 10 is a flow chart depicting a power delivery method according to an example embodiment.

### DESCRIPTION OF EXAMPLE EMBODIMENTS

### Overview

Presented herein are configurations for a power delivery apparatus that employs single step high voltage direct to component rail power conversion combined with a feedback loop to adjust voltage of a power waveform at a power transmitter. In one embodiment, the power delivery apparatus includes a power transmitter configured to generate a power waveform at a first voltage. The power waveform includes a series of successive on-times that are separated by an off-time. A transformer is coupled to the power transmitter, wherein the transformer is configured to receive the power waveform and perform a single step down conversion of the power waveform at the first voltage to an output waveform at a second voltage. A rectifier circuit is coupled to the transformer to receive the output waveform and produce a direct current (DC) rail voltage for use by one or more power consuming devices.

### Example Embodiments

In power delivery applications, such as delivering power to an Application Specific Integrated Circuit (ASIC) that is mounted to a printed circuit board, power needs to be coupled to the PCB and routed through point-of-loads (POLs) that are connected the ASIC. This can involve many layers in the PCB for power distribution over copper to the ASIC.

Efforts have been made to develop a more effective method of supplying hundreds of amps of current at very low voltages, such as 1.2 volt (V) to 0.62 V levels, for an integrated circuit (e.g., application specific integrated circuit (ASIC)) or signal/data processing components attached to an ASIC.

The embodiments presented herein involve deploying a transformer near the delivery destination, e.g., an integrated circuit, and communicating a power waveform (generated remotely from the integrated circuit. The transformer (in a single step-down conversion) converts the higher voltage power waveform (e.g., 400 volts (V)) to a suitable “rail” voltage that is used by the integrated circuit. The rail voltage may be, for example, 1.2 volts (V), 0.92 V, 0.62 V, etc. In one example, the voltage of the power applied to the transformer is relatively high voltage, such as 350 volts to 400 volts or higher, and the DC rail voltage is in the range of 0.6 volts to 1.8 volts or slightly higher. Thus, the step-down voltage conversion from the voltage of the power waveform to the DC rail voltage is significant, but achieved in an efficient manner that can be deployed in a relatively small form factor.

A feedback loop from circuitry associated with the transformer may be used to control the voltage of the power waveform in order to maintain a desired voltage level of the rail voltage.

The techniques presented herein can significantly reduce the amount of copper/conductive material used for power delivery to an integrated circuit or other power consuming devices. A one-step approach is provided to derive component rail power from a high voltage power waveform. For example, a single step conversion is made from 380 volts direct current (VDC) to a DC rail voltage suitable for consumption by central processor unit (CPU)/data processor unit (DPU)/graphics processor unit (GPU)/ASIC.

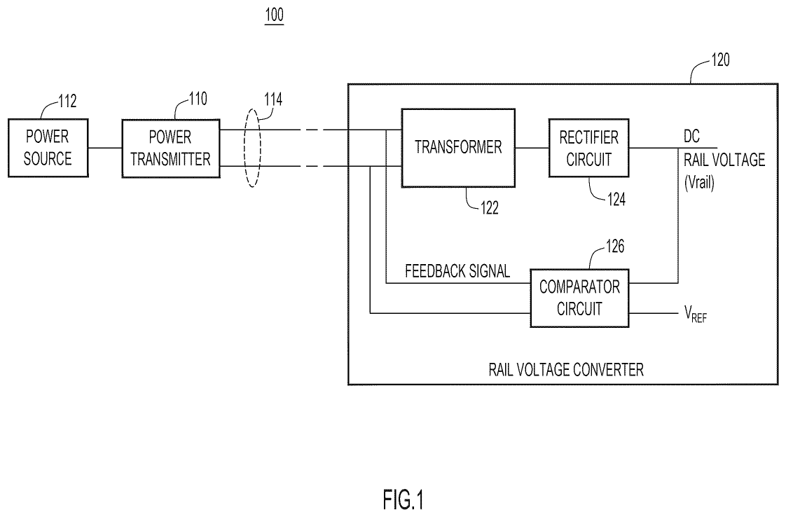

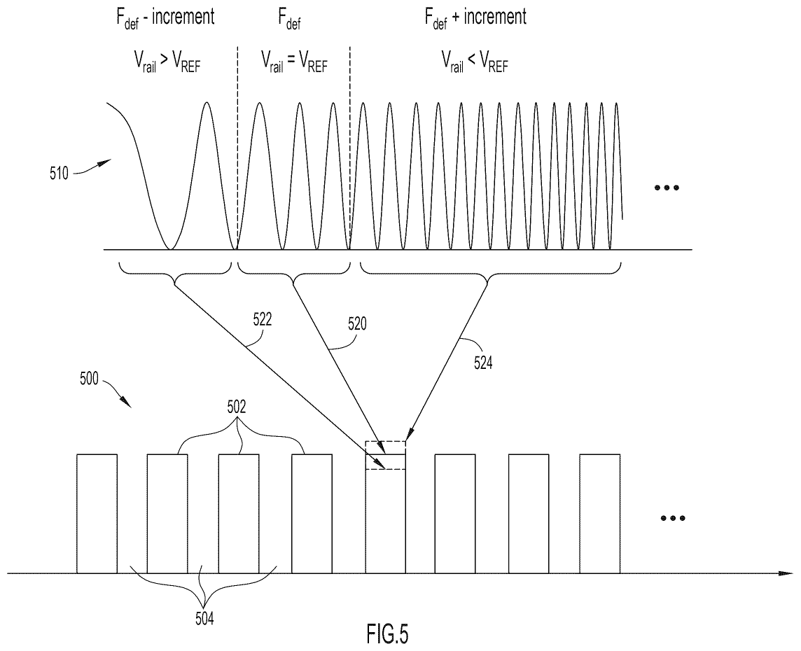

To this end, reference is now made to FIG. 1. FIG. 1 illustrates a high-level block diagram of a power delivery apparatus 100 that is configured to transmit a power waveform to a rail voltage converter that converts the power waveform to a rail voltage for use by one or more power consuming devices, such as an integrated circuit. The power delivery apparatus 100 includes a power transmitter 110 configured to connect to a rail voltage converter 120. A power source 112 provides alternating current (AC) or direct current (DC) input power to the power transmitter 110. The power transmitter 110 is connected to the rail voltage converter 120 by a wire pair 114, and generates a power waveform at a first voltage. The power waveform comprises a series or sequence of successive on-times that are separated by an off-time. The power waveform may be a periodic waveform having a rectangular or other shape, for example, as described below in connection with FIG. 5.

The rail voltage converter 120 includes a transformer 122, a rectifier circuit 124 and a comparator circuit 126. The transformer 122 is configured to receive the power waveform from the power transmitter 110 via the wire pair 114 and perform a single step-down conversion of the power waveform at the first voltage to an output waveform at a second voltage. The rectifier circuit 124 is coupled to the transformer 122 to receive the output waveform and produce a DC rail voltage for use by one or more power consuming devices, such as an integrated circuit. The comparator circuit 126 is configured to compare the DC rail voltage (Vᵣₐᵢₗ) with a reference voltage (V_{REF}) and generate a feedback signal that is communicated to the power transmitter 110. The power transmitter 110 is configured to adjust the voltage (the aforementioned “first voltage”) of the power waveform in response to the feedback signal so as to maintain the DC rail voltage at a desired voltage level.

In one example, the power source 112 provides AC or DC input power at 1000 watts (W) after isolation and conversion. The power transmitter 110 produces a high voltage power waveform. In one example, the voltage (the aforementioned “first voltage”) of the high voltage power waveform is in the range of 120V to 500 V. In one example, the high voltage power waveform is 380 or 400 VDC. The transformer 122 of the rail voltage converter 120 in a single-step, transforms the high voltage power waveform to a much lower voltage output waveform (at a second voltage). The rectifier circuit 124 converts the output waveform from the transformer 122 to a DC rail voltage. For example, the DC rail voltage may be in the range of 0.5 V to 1.6 V, at 100A to 500A, for example. The length of the wire pair 114 between the power transmitter 110 and the rail voltage converter 120 may vary, but may be up to one meter (m).

The feedback signal generated by the comparator circuit 126 may be communicated (as a periodic feedback waveform) over the wire pair 114 back to the power transmitter 110 to cause the power transmitter 110 to adjust the voltage of the power waveform. It is also envisioned that the feedback signal may be communicated over a separate channel (not over the wire pair 114) if one is available between the comparator circuit 126 and the power transmitter 110.

As described in more detail below, the power transmitter 110 may generate the power waveform to include a sequence or series of successive on-times separated by off-times in one of several ways. In a first arrangement, the power transmitter 110 may generate a pulse power waveform that comprises successive power on-times separated by power off-times, where the power off-times are used to detect a fault on the wire pair or elsewhere in the power delivery apparatus 100. Thus, the pulse power waveform is also referred to as Fault Managed Power (FMP) because it allows for fault detection during the power off-times. In a second arrangement, the power transmitter 110 may generate a continuously-on power waveform, and a switch arrangement is provided to switch the continuously-on power waveform on and off to generate a series of successive on-times separated by off-times. In both arrangements, the repetitive switching between a power-on state and a power-off state creates the desired change in polarity in the power waveform for the transformer 122 to perform its step-down conversion of the voltage level of the power waveform. The transformer 122 transfers power between its primary winding and secondary winding(s) during the on-time of power waveform, unlike a fly-back transformer circuit arrangement that transfers power during off-times.

The power delivery apparatus 100 (and in particular the rail voltage converter 120) shown in FIG. 1 can be made to be very small and compact, and can replace current board mount power designs. As an example, a 1000 W power transmitter uses less than 3 amps (A) and makes power distribution easy. In addition, the layer count and copper weight used for power distribution into an integrated circuit can be greatly reduced using these techniques. Further still, the power delivery apparatus 100 does not require a bus bar.

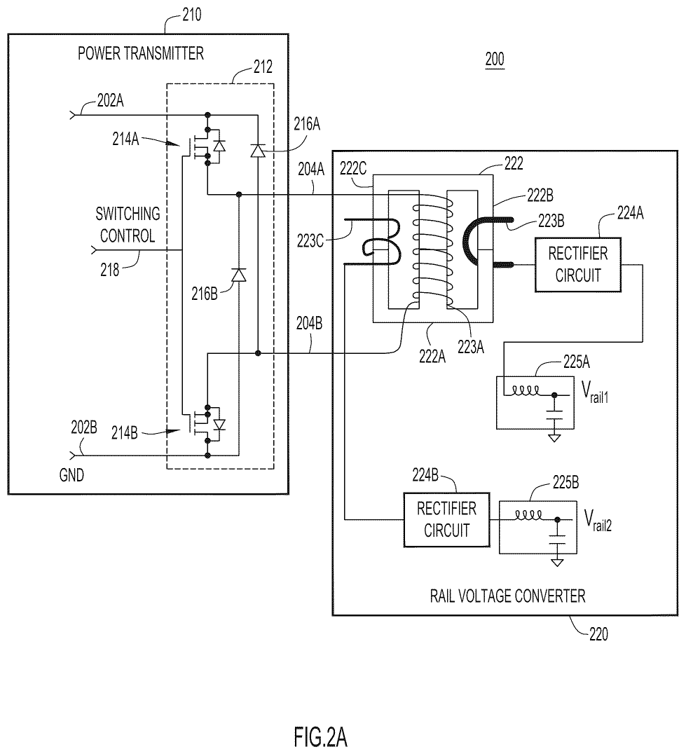

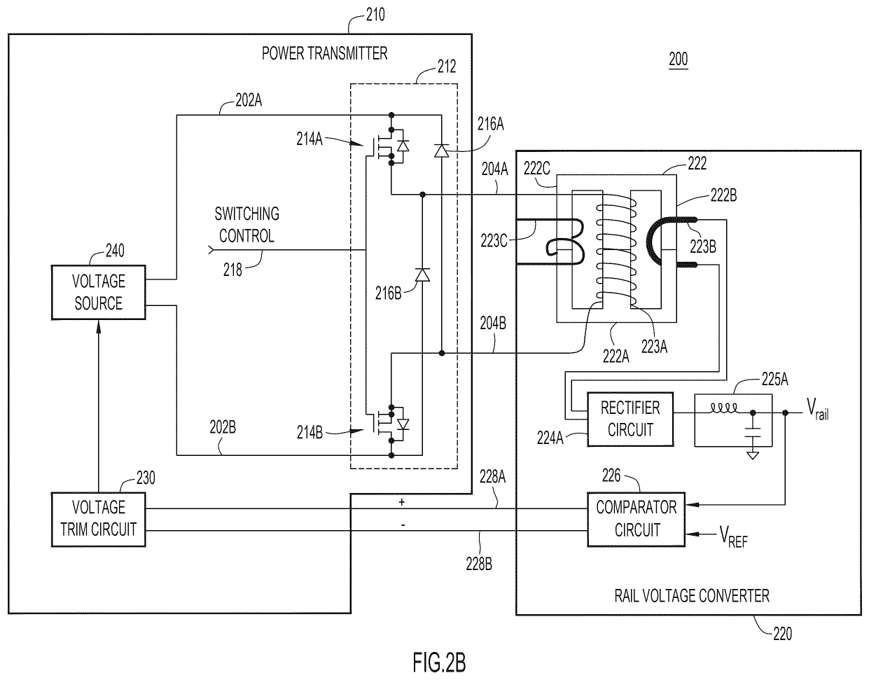

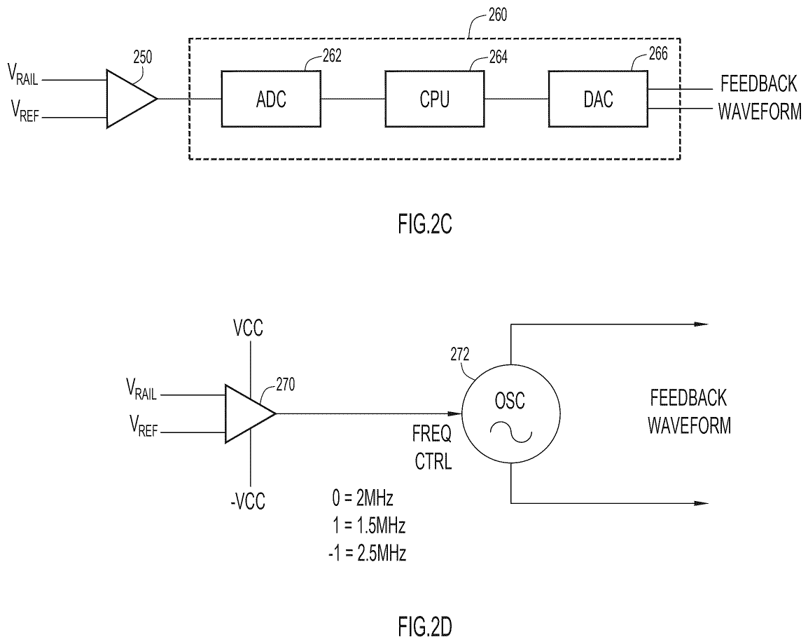

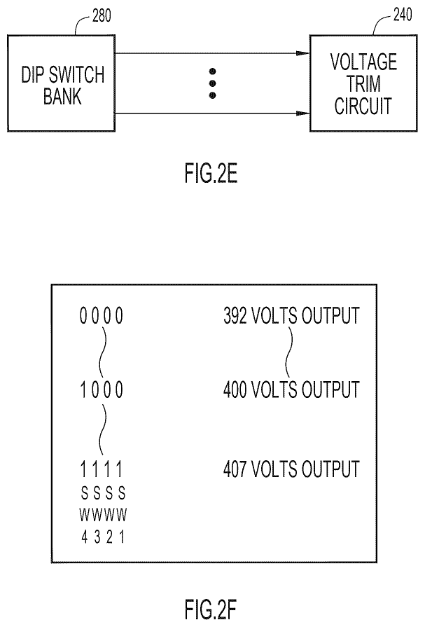

FIG. 2A illustrates a more detailed diagram of a power delivery apparatus 200, according to an example embodiment. The comparator circuit in the rail voltage converter is not shown in FIG. 2A, for simplicity, and is not required in some embodiments. In particular, FIG. 2A shows a power transmitter 210 that includes a switching circuit 212 that is optional and used when the power transmitter 210 is of a type that provides a continuously-on power waveform. The switching circuit 212 resides between power transmitter outputs 202A and 202B and a wire pair comprising wires 204A and 204B. The switching circuit 212 includes a first transistor switch 214A and a second transistor switch 214A. The first transistor switch 214A is connected between the power transmitter output 202A and the wire 204A and the second transistor switch 214B is connected between the power transmitter output 202B and the wire 204B. In addition, the switching circuit 212 may include a first diode 216A connected between power transmitter output 202A and the second transistor switch 214B, and a second diode 216B connected between power transmitter output 202B and the first transistor switch 214A. The switching circuit 212 further includes a switching control input 218 that is connected to the first transistor switch 214A and the second transistor switch 214B. The power transmitter 210 (or a separate controller) provides a control waveform to the switching control input 218 to alternatingly switch the first and second transistor switches 214A and 214B on and off so as to generate power waveform that alternates between power-on times and power off-times. The power waveform is provided to the wires 204A and 204B. In one example, the control waveform is an 8 V waveform that has 15%/85% on/off duty cycle. As mentioned above, the switching circuit 212 is not needed if the power transmitter 210 generates a power waveform that inherently switches between on-times and off-times. In one example, the voltage level of the power waveform is 380 VDC.

Still referring to FIG. 2A, the power delivery apparatus 200 includes rail voltage converter 220 that includes transformer 222. The example arrangement of the rail voltage converter 220 of the power delivery apparatus 200 can generate two different DC rail voltages through the use of a first rectifier circuit 224A and a second rectifier circuit 224B. The transformer 222 is a three-monument transformer that includes a central monument 222A and a primary winding 223A around the central monument, a first secondary monument 222B and a first secondary winding 223B around the first secondary monument 222B, and a second secondary monument 222C and a second secondary winding 223C around the second secondary monument 222C. In one example, the primary winding 223A has 100 turns of 28 gauge American Wire Gauge (AWG) wire, the first secondary winding 223B is one turn of copper foil (1.4 inches wide) and the second secondary winding is two turns of 0.25 in wide copper foil. The number of turns of the primary winding 223A can be adjusted to achieve the desired output voltage level from the transformer. The transformer 222 steps down the voltage (e.g., 300 V or more) of the power waveform supplied to the primary winding 223A in a single-step, to a substantially lower voltage level suitable for providing rail voltage power to an integrated circuit.

The wire pair consisting of wires 204A and 204B are connected to opposite ends of the primary winding 223A to provide the power waveform to the transformer. In this example, the transformer 222 provides a first output waveform to first secondary winding 223B and a second output waveform to the second secondary winding 223C. The first rectifier circuit 224A has an input that is connected to the first secondary winding 223B, and the second rectifier circuit 224B has an input that is connected to the second secondary winding 223C.

The first rectifier circuit 224A converts the first output waveform from the first secondary winding 223B to a DC voltage. An inductor-capacitor filter 225A may be provided at the output of the first rectifier circuit 224A to filter the output of the first rectifier circuit 224A to produce a first DC rail voltage, Vᵣₐᵢₗ₁. Similarly, the second rectifier circuit 224B converts the second output waveform from the second secondary winding 223C to a second DC voltage. An inductor-capacitor filter 225B may be provided at the output of the first rectifier circuit 224B to filter the output of the first rectifier circuit 224B to produce a second DC rail voltage, Vᵣₐᵢₗ₂. The first and second rectifier circuits 224A and 224B may be DC bridge diodes or field effect transistor (FET) rectifier circuits.

The transformer 222 and associated circuitry in the rail voltage converter 220 can be compact and achieve a relatively high current output with high efficiency. For example, the rail voltage converter 220 can be implemented in a space of 10 mm by 40-60 mm by 30 mm, or smaller. The transformer 222 achieves the desired electrical isolation and thus there is no need for additional isolation circuitry in the rail voltage converter 220.

Turning now to FIG. 2B, a diagram is shown of the power delivery apparatus 200, similar to that shown in FIG. 2A, but including a rectifier circuit and a comparator circuit and showing more details about the feedback loop. For simplicity, the circuitry shown in the rail voltage converter 220 in FIG. 2B is for the rail voltage derived from the first secondary winding 223B. Similar circuitry would be provided for the second secondary winding 223C but not shown in FIG. 2B for simplicity. Specifically, in FIG. 2B, there is a rectifier circuit 224A coupled to the first secondary winding 223B to produce an output voltage that results in the DC rail voltage Vᵣₐᵢₗ. A comparator circuit 226 is coupled to receive, at a first input, the DC rail voltage, and at a second input, to receive a reference voltage V_{REF}. The comparator circuit 226 compares the DC rail voltage Vᵣₐᵢₗ with the reference voltage V_{REF} and generates as output a feedback waveform. The power transmitter 210 further includes a voltage trim circuit 230 and a voltage source 240. The comparator circuit 226 generates differential outputs 228A and 228B that are coupled as inputs to the voltage trim circuit 230, for example, via a wire pair included in the cable that contains wires 204A and 204B. The voltage trim circuit 230 generates an output that is coupled to the voltage source 240 that provides power to the power transmitter outputs 202A and 202B, respectively. In this way, the feedback waveform is communicated to the power transmitter 210. The feedback waveform may be a sine wave or square wave, and the frequency of the feedback waveform is used to indicate what, if any, adjustment needs to be made to the voltage of the power waveform. An example of the feedback waveform is described below in connection with FIG. 5. Thus, as the load transitions up and down, adjustments may be made at the power transmitter 210 to adjust the voltage of the power waveform provided to the transformer 222 in order to achieve the desired voltage level for the DC rail voltage, Vᵣₐᵢₗ. Again, if the second secondary winding 223C is being used for a second rail voltage, then another instance of the comparator circuit 226 would be provided that is coupled to the output of inductor-capacitor filter 225B (as shown in FIG. 2A)

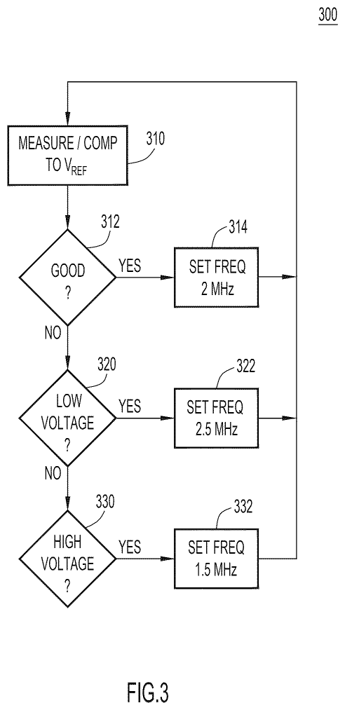

Reference is now made to FIGS. 2C and 2D for examples of the comparator circuit 226. In an example digital implementation shown in FIG. 2C, the comparator circuit 226 may be embodied by a comparator 250 and digital signal processor (DSP) integrated circuit 260 that includes an analog-to-digital converter (ADC) 262, a central processing unit (CPU) 254 and a digital-to-analog converter (DAC) 266. The comparator 250 compares Vᵣₐᵢₗ with V_{REF} and generates an analog output signal that is coupled to the ADC 262. The ADC 262 converts the analog output signal to a digital signal that is supplied to the CPU 264. The CPU 264 processes the digital signal to generate characteristics of a feedback waveform having a frequency that depends on the comparison between Vᵣₐᵢₗ with V_{REF} in accordance with the logic depicted in FIG. 3 and described below. The DAC 266 converts the output of the CPU 264 to an analog feedback waveform that is coupled to the voltage trim circuit 230 in the power transmitter 210.

FIG. 2D illustrates an example analog implementation of the comparator circuit 226. In this implementation, the comparator circuit 226 includes a comparator 270 and an oscillator 272 that has a frequency control (CTRL) input. The comparator 270 is configured to generate one of three outputs depending on the comparison between Vᵣₐᵢₗ and V_{REF} and which is provided as the frequency control input to the oscillator 272. For example, the nominal frequency of the feedback waveform at the output of the oscillator 272 is 2 MHZ, and the oscillator 272 increased or decreases the frequency of the feedback waveform depending on the comparison between Vᵣₐᵢₗ and V_{REF} as described further below in connection with FIG. 3.

The voltage trim circuit 230 can be manually configured to adjust the voltage output by the voltage source 240. Some underlying theory is first provided. The length of a cable carrying wires 204A and 204B from the power transmitter 210 to the transformer 222 in the rail voltage converter 220 is known. The output voltage of the power transmitter 210 is generally a constant. For example, if set to 400 VDC, it will be always 400 V DC until there is not enough current, at which time the voltage source 240 will go into an over-current protection and shut down. The Vᵣₐᵢₗ to be provided as output to an ASIC and associated current draw range of the ASIC are generally known, according to ASIC application. V_{Tx}-V_{cable_drop}-V_{Transformer}=Vᵣₐᵢₗ, where V_{Tx} is the value to be set and V_{Transformer} is by design.

If the current of the power transmitter is set to approximately 3 amps and the voltage V_{Tx} is set to approximately 400 V, then the associated power is approximately 1200 Watts. V_{cable_drop} at 3 amps over one meter on a 24 AWG cable is less than 1 V. Thus, the Vᵣₐᵢₗ that is needed can be determined. Accordingly, V_{Tx}=Vᵣₐᵢₗ+V_{cable_drop}+V_{Transformer}.

As shown in FIG. 2E, a DIP switch bank 280 may be provided to allow for manually configuring the voltage adjustment made by the voltage trim circuit. The DIP switch bank 280 may include 4 DIP switches to trim voltage in one (1) volt steps as shown in FIG. 2F to cover different ranges of voltage for V_{Tx}. In this example, the voltage steps start at 392 V with the DIP switches (sw4,sw3,sw2,sw1) set to “0000”, and go to 400 V with the DIP switches set to “1000” and to 407 V with the DIP switches set to “1111”.

Reference is now made to FIG. 3. FIG. 3 shows a flow chart depicting a method 300 that may be performed by the rail voltage converter (and the comparator circuit 226 in particular) to generate the feedback waveform referred to above. The frequency of the feedback waveform is used to encode or indicate whether the voltage of the power waveform should be kept where it is, increased or decreased. The method 300 includes, at step 310, the comparator circuit 226 compares the DC rail voltage with a voltage reference, V_{REF}. When, at step 312, it is determined that the difference between the DC rail voltage and the voltage reference is zero or some nominal amount, this indicates that the DC rail voltage is at a desired level, and no change needs to be made to the voltage of the power waveform provided by the power transmitter. Thus, the frequency of feedback waveform is kept (or set) to a default frequency (e.g., 2 MHz), at step 314. On the other hand, when at step 312 it is determined that the difference between the DC rail voltage and the voltage reference is not acceptable, then at step 320, it is determined if the level of the DC rail voltage is low. If it is determined that the level of the DC rail voltage is low (relative to the voltage reference), then at step 322, the frequency of the feedback waveform is increased by a predetermined incremental amount, e.g., by 0.5 MHz to 2.5 MHz. On the other hand, if at step 330 it is determined that the DC rail voltage is high (relative to the voltage reference), then at step 332, the frequency of the feedback waveform is decreased by a predetermined incremental amount, e.g., by 0.5 MHz to 1.5 MHz. The method 300 may repeat on a periodic basis.

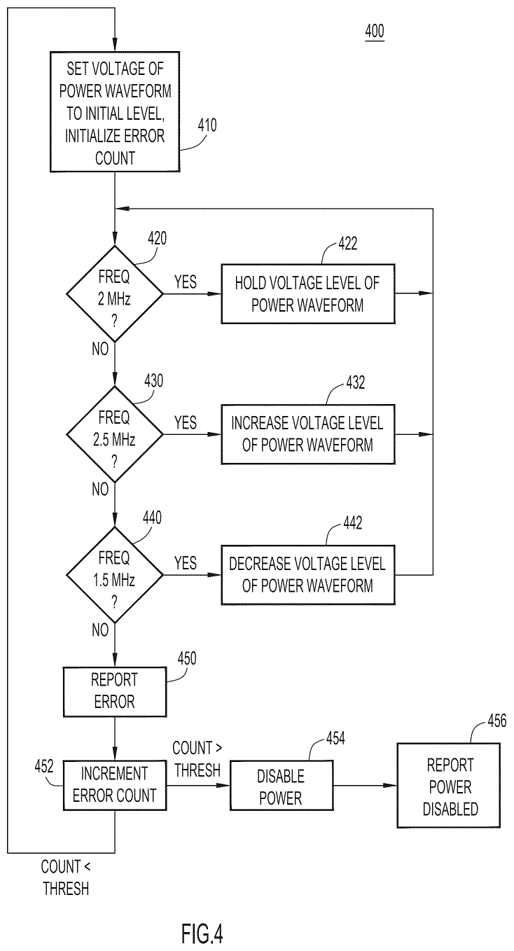

Reference is now made to FIG. 4 for a description of a flow chart for a process 400 performed by the power transmitter for controlling the voltage level of the power waveform. At step 410, the voltage of the power waveform is set to an initial or desired level. In addition, in step 410, an error count is initialized, to enable error reporting, as described below. The power transmitter then monitors the incoming feedback waveform, and in particular evaluates the frequency of the feedback waveform. If at step 420, the power transmitter determines that the frequency of the feedback waveform is at a predetermined default frequency, e.g., 2 MHZ, then at step 422, the power transmitter holds the voltage level of the power waveform where it is (the initial or desired level). If at step 420, the power transmitter determines that the frequency of the feedback waveform is not at the predetermined default frequency, then at step 430, it determines whether the frequency of the feedback waveform is at first increased frequency (e.g., 2.5 MHz), and if so, then the power transmitter increases the voltage of the power waveform by one step or incremental amount (e.g., 5 V, or some other incremental amount), at step 432. If at step 430 the power transmitter determines that the frequency of the feedback waveform is not increased by a predetermined amount relative to the predetermined default frequency (e.g., to 2.5 MHz), then at step 440, the power transmitter determines whether the frequency of the feedback waveform has been decreased by a predetermined amount relative to the predetermined default frequency (e.g., to 1.5 MHz). At step 442, the power transmitter decreases the voltage of the power waveform by one step or incremental amount (e.g., 5 V). If at step 440 the power transmitter determines that the frequency of the feedback waveform has not been decreased by a predetermined amount, then the method proceeds to step 450 where an error is declared and reported. Next, at step 452, the error count is incremented. If the error count is greater than a threshold, then a step 454, power is disabled and at step 456 a report is made that the power has been disabled. If the error count is less than the threshold, then the process 400 repeats from step 410. The error threshold may be set to 3, in one example. Thus, if the feedback waveform does not match any of the frequencies (at steps 420, 430 and 440) three times, then an error has occurred and initialization is re-attempted. In this way, the output power can be fine-tuned with no additional switching circuit loss.

Thus, when the frequency of the feedback waveform is:
Default Frequency (e.g., 2 MHZ)−Rail voltage is good and no change is needed
Default Frequency+some incremental amount (e.g., 2.5 MHz)−Rail voltage is low so need to increase the voltage level of the power waveform
Default Frequency−some incremental amount (e.g., 1.5 MHz)−Rail voltage is high so need to decrease the voltage of the power waveform

Reference is now made to FIG. 5. This figure shows a power waveform 500 and a feedback waveform 510. In this example, the power waveform 500 is a series of successive pulses of power on-times 502 separated by power off-times 504. The duty cycle of the power on-times relative to the power off-times may vary, and FIG. 5 is not meant to be suggestive of a particular duty cycle. The height or level of the pulses or power on-times 502 determines the voltage level of the power waveform 500 and thus the voltage level generated at the output of the rail voltage converter, referred to above, by operation of the transformer and rectifier circuit. It should be understood that the power waveform 500 need not have a square/rectangular wave shape, and it could be other shapes, such as a sinusoidal wave shape, triangular, etc.

The feedback waveform 510 may be a periodic waveform (of a sinusoidal or other shape) and the frequency of the feedback waveform 510 is used to signal the level of Vᵣₐᵢₗ relative to the voltage reference V_{REF}. When Vᵣₐᵢₗ is substantially equal to V_{REF} (within some tolerance), the rail voltage converter keeps the frequency of the feedback waveform 510 at a default or nominal value referred to as F_{def}. The power transmitter detects that the frequency of the feedback waveform 510 is at the default or nominal value and does not change the voltage level of the power waveform 500, as shown at 520. When Vᵣₐᵢₗ is greater than V_{REF}, then the rail voltage converter reduces the frequency of the feedback waveform by an incremental amount (F_{def}−increment). The power transmitter detects that the frequency of the feedback waveform is an incremental amount below the default frequency value, and in response, decreases the voltage of the power waveform, i.e., by reducing the level of the pulses during the power on-times 502, as shown at 522. Conversely, when Vᵣₐᵢₗ is less than V_{REF}, then the rail voltage converter increases the frequency of the feedback waveform by an incremental amount (F_{def}+increment). The power transmitter detects that the frequency of the feedback waveform is an incremental amount above the default frequency value, and in response, increases the voltage of the power waveform, i.e., by increasing the level of the pulses during the power on-times 502, as shown at 524. It should be understood that the logic could be reversed such that when Vᵣₐᵢₗ is less than V_{REF}, the rail voltage converter could decrease the frequency of the feedback waveform by an incremental amount (F_{def}−increment) and when Vᵣₐᵢₗ is greater than V_{REF}, then the rail voltage converter could increase the frequency of the feedback waveform by an incremental amount (F_{def}+increment).

The feedback loop described above is not required. Instead, a “second step” in the transformer conversion can be added to regulate the component rail power directly at the transformer secondary windings. In some cases, this may not be as desirable, and for component distribution it may be simpler to adjust the voltage at the power transmitter side for fine control on the secondary side of the transformer.

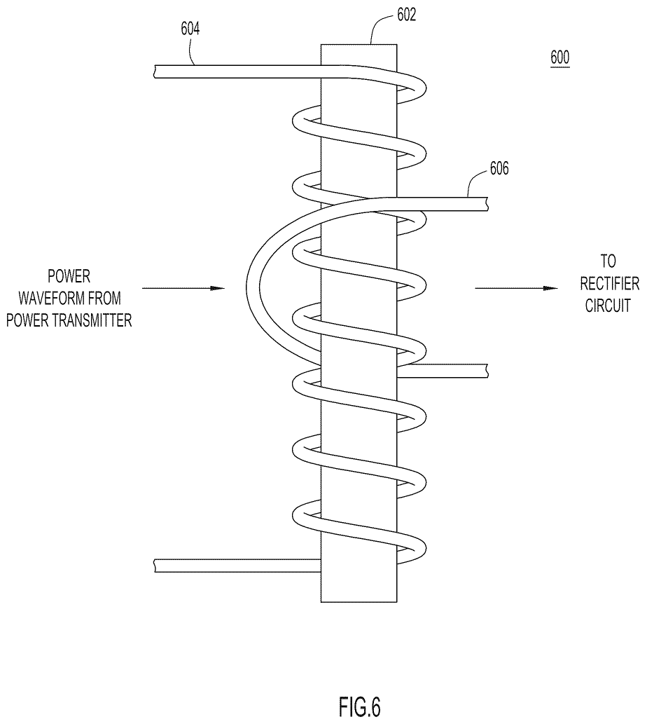

FIG. 6 shows a single ferrite structure design for a transformer that may be used in the rail voltage converter for the various embodiments presented herein. The transformer 600 is a single (open) core, as opposed to the three-monument design of the transformer shown in FIGS. 2A and 2B. The transformer comprises a single core 602, a primary winding 604 around the core 602 and a secondary winding 606 around the primary winding 604. The power waveform from the power transmitter is coupled to the primary winding 604 and the secondary winding is connected to the rectifier circuit (not shown in FIG. 6 for simplicity).

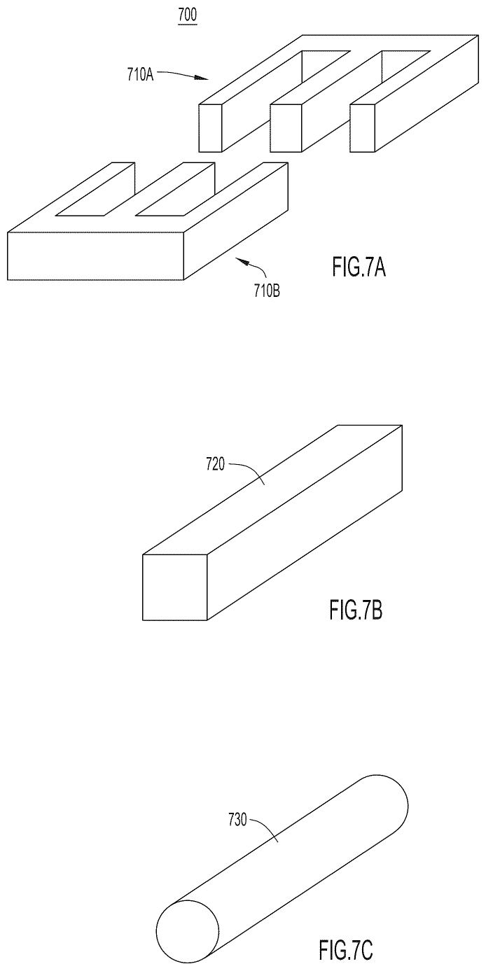

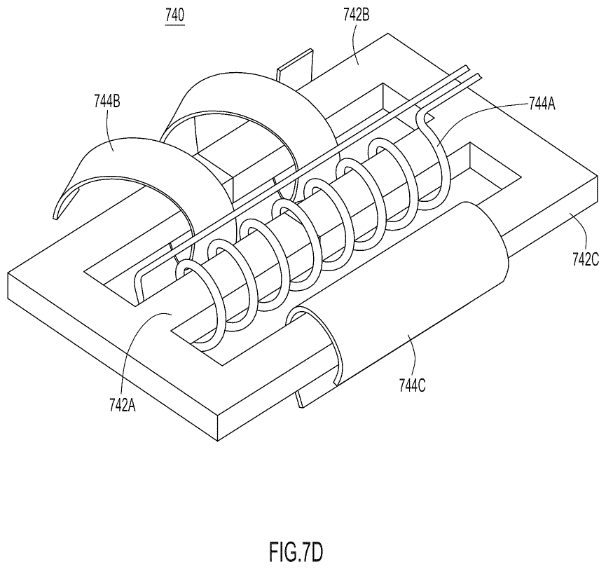

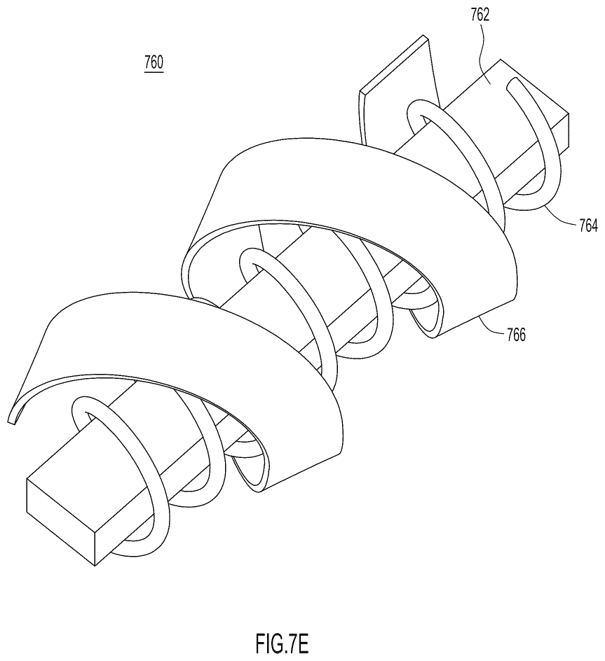

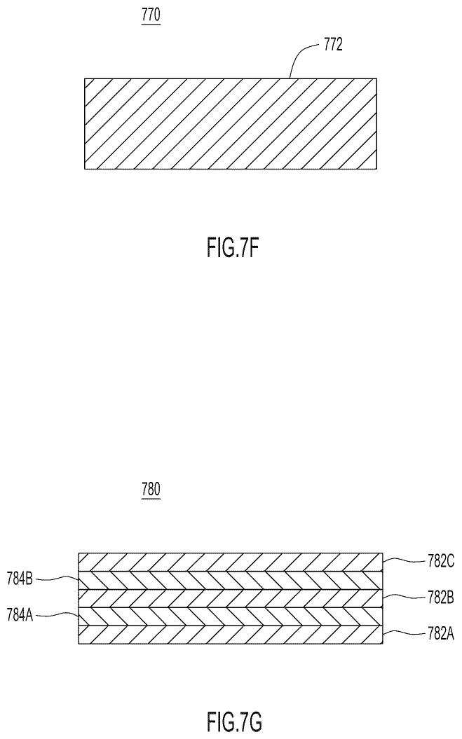

Reference is now made to FIGS. 7A-7G that show examples of designs for a transformer that may be used in the system and configurations presented herein. FIG. 7A shows a three-monument transformer 700 that may have a two-piece design comprising a first portion 710A and a second portion 710B. Each of the first and second portions 710A and 710B comprises three-monument portions that connect together through an alignment mechanism to form the three-monument transformer. It is also envisioned that only one of the first portion 710A and the second portion 710B may be sufficient to form the transformer 700. A multi-monument transformer as shown in FIG. 7A has an advantage of being capable of handling higher power.

As shown in FIG. 7B, a transformer monument 720 (whether for a three monument transformer as shown in FIG. 7A or a single monument/single core transformer) may have a rectangular-rectangular cross-section or a square-rectangular cross section. Alternatively, as shown in FIG. 7C, a transformer monument 730 (whether for a three monument transformer as shown in FIG. 7A or a single monument/single core transformer) may have a circular cross section/cylindrical shape.

FIG. 7D shows a multi-monument transformer 740 in more detail, according to an example embodiment. In one example, the transformer 740 includes three monuments: a central monument 742A, a first secondary monument 742B and a second secondary monument 742C, but could have any number of monuments.

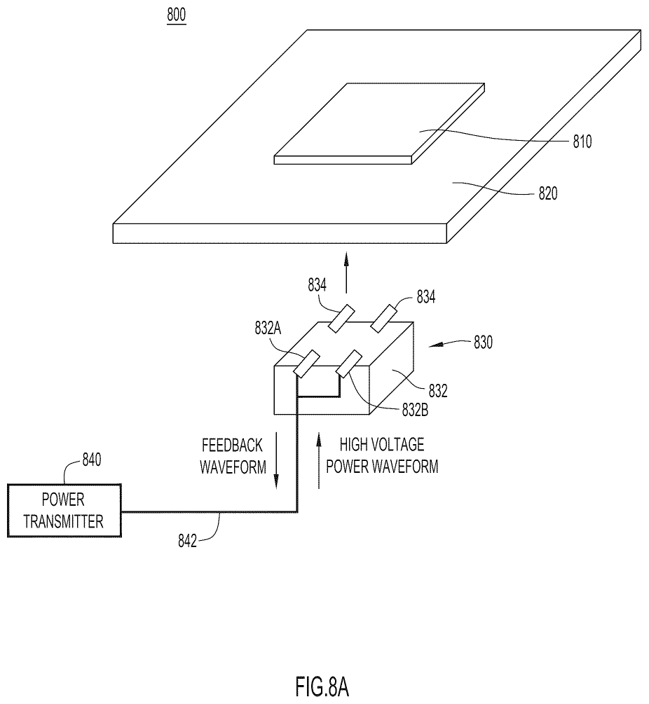

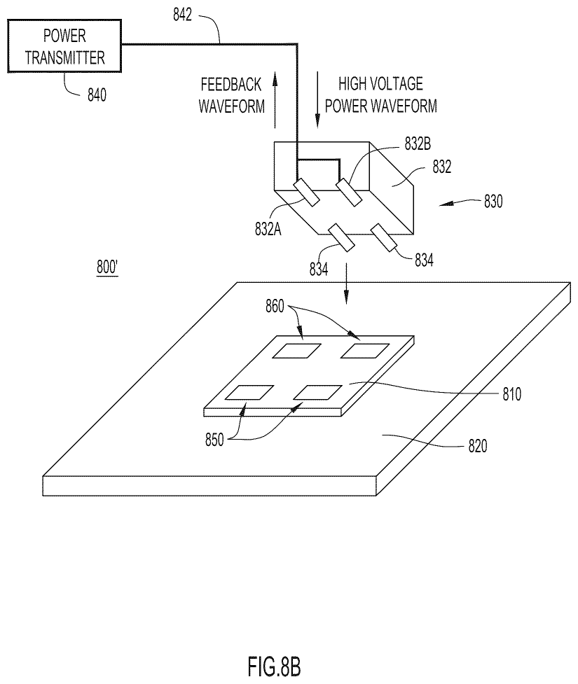

A primary winding 744A is wrapped around the central monument 742A. The primary winding is the high-voltage winding because it receives the high-voltage power waveform from the power transmitter. In one example, the primary winding is made of 22 AWG to 30 AWG insulated and/or enameled wire. The primary winding 744A may be relatively tightly wrapped around the central monument 742A. A first secondary winding 744B wraps around the first secondary monument 742B. In one example, the first secondary winding 744B comprises two turns of thick copper foil for a first (higher) rail voltage. For example, the first secondary winding is 250 mil wide×5 mil thick copper foil. A second secondary winding 744C wraps around the second secondary monument 742C. The second secondary winding 744C may comprise one turn (or almost one turn) of wide copper foil (e.g., 1 mil to 100 mil thick) tightly wrapped, but not shorting (that is, not fully around the second secondary monument 742C), for a second rail voltage. The second secondary winding 744C could be two pieces of copper foil broken up into 2 separate turn portions. As will be described below in connection with FIGS. 8A and 8B, the transformer 740 (within an appropriate package or housing) can be soldered to the back of an integrated circuit and the rail voltages connected into the integrated circuit (from the rectifier circuits).

FIG. 7E shows a transformer 760 having a single monument construction. The transformer 760 comprises a monument 762 with a primary winding 764 formed from a high voltage wire wrapped around the monument 762 closest to the core/center of the monument 762. A secondary winding 766 made of copper foil is wrapped around the outside of the primary winding 764. There may be a thin insulation between the primary winding 764 and the secondary winding 766. Also, the transformer 760 may have multiple primary windings: one with more turns than the other to provide selectable ranges of input voltage. In addition, there may be more than one copper foil winding overlaying or overlapping the primary winding(s). Moreover, as described below in connection with FIG. 7G, the copper foil used for the primary and/or secondary winding(s) could be integrated with graphene.

FIG. 7F shows a cross-section of a copper foil 770 that is solid copper 772. This may be used for a winding in any of the embodiments/configuration presented herein that involve use of a copper foil.

FIG. 7G shows a cross-section of a copper foil 780 that is comprised of multiple layers. For example, there are three copper layers 782A, 782B and 782C with two graphene layers 784A and 784B between copper layers to improve efficiency. Graphene may be used in the primary and secondary windings. Again, in the case of a single monument transformer, the primary winding is first applied to a monument/ferrite core, and the secondary winding may be wrapped over the primary winding, optionally with a high voltage isolation dielectric material between them.

Reference is now made to FIG. 8A. FIG. 8A shows a perspective view of a power delivery arrangement 800 employing the techniques presented herein. An integrated circuit package 810 is mounted on a printed circuit board (PCB) 820. A rail voltage converter package 830 is provided that includes therein a transformer (of any of the types described herein), one or more rectifier circuits and a comparator circuit, all contained within a housing or enclosure 832. A power transmitter 840 is coupled via the wire pair 842 to input leads 832A and 832B on the rail voltage converter package 830 to provide the high voltage power waveform to the rail voltage converter package 830.

The rail voltage converter package 830 has output leads 834 and is soldered or otherwise affixed to the underside of the integrated circuit package 810 or underside of the PCB 820. The rail voltage(s) produced by the rail voltage converter package 830 are connected via the output leads 834 to the integrated circuit package 810 or to PCB 820. In addition, the feedback waveform produced by the rail voltage converter package 830 is coupled by the wire pair 842 to the power transmitter 840. All the power components (e.g., power source and power transmitter) are separate from the integrated circuit package 810 and PCB 820 and just connected to the transformer by the wire pair 842.

FIG. 8B illustrates a power delivery arrangement 800′ that is a variation of the power delivery arrangement 800 shown in FIG. 8A. In the power delivery arrangement 800′, the direct attach of power is to the top side of an integrated circuit, rather than the bottom side of a PCB 820 as shown in FIG. 8A. The integrated circuit package 810 may include anchor pads 850 to support the rail voltage converter package 830 and rail pads 860 to connect with the output leads 834 on the rail voltage converter package 830. Cooling of the power delivery arrangement 800′ may be achieved in many ways, including liquid cooling, air cooling, etc., all of which are adaptable to the top side direct attach method depicted in FIG. 8B.

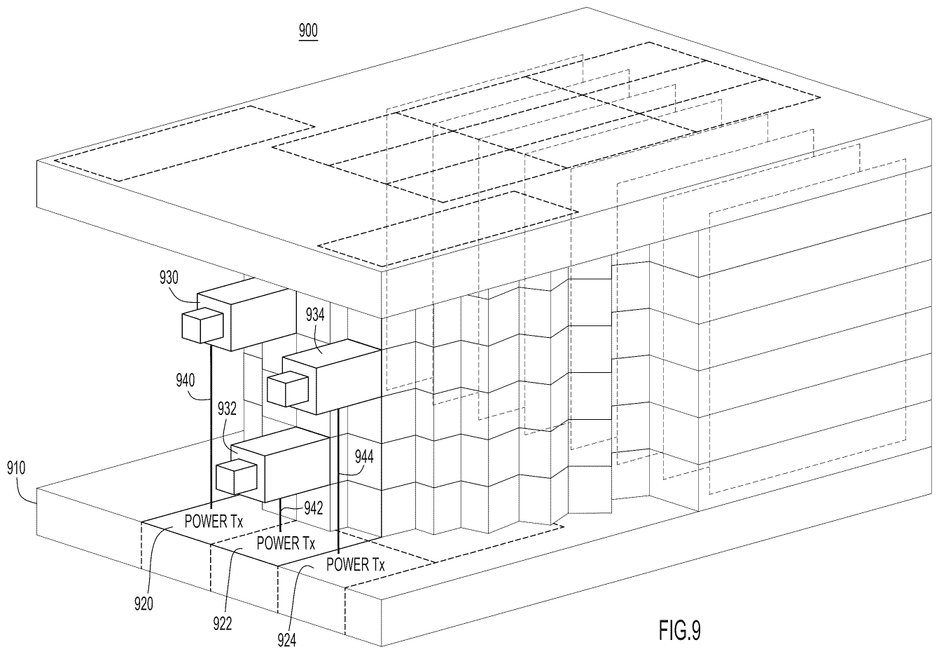

Turning now to FIG. 9, a perspective view is shown of an electronic device 900 having a plurality of PCB layers for power and other functions as well as processing modules or devices. In a bottom layer 910, there are power transmitters (power Tx) 920, 922 and 924, and the plurality of layers above the bottom layer 910, there are processing modules 930, 932 and 934 that plug into an associated slot or receptacle in an associated layer. The power Tx 920 is connected by wire pair 940 to processing module 930, the power Tx 922 is connected by wire pair 942 to processing module 932 and the power Tx 924 is connected by wire pair 944 to processing module 934. The processing modules 930, 932 and 934 could be networking processors, graphic processors, artificial intelligence (AI) processors, etc.

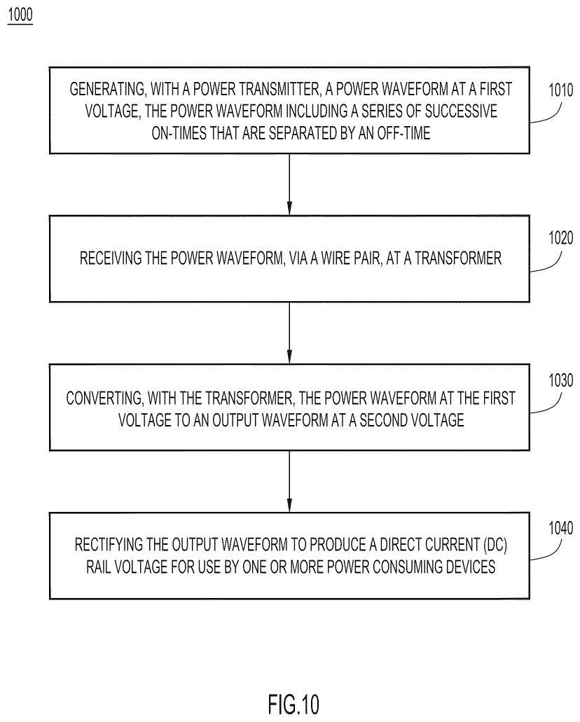

FIG. 10 illustrates a flow chart depicting a method 1000 according to an example embodiment. The method 1000 involves providing a DC rail voltage to one or more power consuming devices. At step 1010, the method includes, generating, with a power transmitter, a power waveform at a first voltage. The power waveform includes a series of successive on-times that are separated by an off-time. At step 1020, the method includes receiving the power waveform, via a wire pair, at a transformer. At step 1030, the method includes converting, with the transformer, the power waveform at the first voltage to an output waveform at a second voltage. At step 1040, the method includes, rectifying the output waveform to produce a direct current (DC) rail voltage for use by one or more power consuming devices.

In summary, presented herein are configurations for a single step source voltage direct to component rail power conversion using a transformer combined with a feedback control loop to adjust voltage at the power transmitter.

In some aspects, the techniques described herein relate to an apparatus including: a power transmitter configured to generate a power waveform at a first voltage, the power waveform including a series of successive on-times that are separated by an off-time; a transformer coupled to the power transmitter, wherein the transformer is configured to receive the power waveform and perform a single step down conversion of the power waveform at the first voltage to an output waveform at a second voltage; and a rectifier circuit coupled to the transformer to receive the output waveform and produce a direct current (DC) rail voltage for use by one or more power consuming devices.

In some aspects, the first voltage is in a range of 350 volts to 400 volts, and the DC rail voltage is in a range of 0.60 volts to 1.8 volts.

In some aspects, the techniques described herein relate to an apparatus, further including a wire pair that connects an output of the power transmitter to a primary winding of the transformer.

In some aspects, the techniques described herein relate to an apparatus, further including a comparator circuit that compares the DC rail voltage with a reference voltage and generates a feedback signal to be communicated to the power transmitter, wherein the power transmitter is configured to adjust the first voltage of the power waveform responsive to the feedback signal so as to maintain the DC rail voltage at a desired level.

In some aspects, the techniques described herein relate to an apparatus, wherein the comparator circuit is configured to generate the feedback signal so as to cause the power transmitter to decrease the first voltage when the DC rail voltage is greater than the reference voltage and to increase the first voltage when the DC rail voltage is less than the reference voltage.

In some aspects, the techniques described herein relate to an apparatus, wherein the feedback signal is a periodic feedback waveform having a frequency that depends on whether the DC rail voltage is substantially equal to the reference voltage, greater than the reference voltage or less than the reference voltage.

In some aspects, the techniques described herein relate to an apparatus, wherein the periodic feedback waveform is at a first frequency when the DC rail voltage is substantially equal to the reference voltage, the periodic feedback waveform is at the first frequency plus an incremental frequency amount when the DC rail voltage is less than the reference voltage, and the periodic feedback waveform is at the first frequency less an incremental frequency amount when the DC rail voltage is greater than the reference voltage.

In some aspects, the techniques described herein relate to an apparatus, wherein the comparator circuit is in is configured to couple the periodic feedback waveform to the power transmitter.

In some aspects, the techniques described herein relate to an apparatus, further including a housing configured to contain the transformer and the rectifier circuit, wherein the housing is configured to mount to an integrated circuit package or to a circuit board on which the integrated circuit package is attached.

In some aspects, the techniques described herein relate to an apparatus, wherein the housing containing the transformer and the rectifier circuit is configured to attach to a bottom side of the circuit board under the integrated circuit package to provide power to the integrated circuit package.

In some aspects, the techniques described herein relate to an apparatus, wherein the integrated circuit package or circuit board to which the integrated circuit package is attached is mounted in a first layer of an electrical device that includes a plurality of layers, and wherein the power transmitter is in a second layer of the electrical device.

In some aspects, the techniques described herein relate to an apparatus, wherein the transformer is a multi-monument transformer including a primary winding around a first monument, the primary winding configured to receive as input the power waveform, and a first secondary winding around a second monument, the first secondary winding configured to output a first output waveform at the second voltage.

In some aspects, the techniques described herein relate to an apparatus, wherein the transformer further includes a second secondary winding around a third monument, the second secondary winding configured to output a second output waveform at a third voltage.

In some aspects, the techniques described herein relate to an apparatus, wherein the primary winding and/or the first secondary winding include a conductive material with one or more layers of graphene.

In some aspects, the techniques described herein relate to an apparatus, wherein the transformer includes a single monument, a primary winding wrapped around the single monument and configured to receive as input the power waveform, and a secondary winding wrapped around the primary winding and configured to provide the output waveform at the second voltage.

In some aspects, the techniques described herein relate to an apparatus including: a power transmitter configured to generate a power waveform at a first voltage, the power waveform including a series of successive on-times that are separated by an off-time; a wire pair having a first end and a second end, the first end coupled to the power transmitter to receive the power waveform; and a rail voltage converter coupled to the second end of the wire pair, the rail voltage converter including: a transformer configured to receive the power waveform and perform a step down conversion of the power waveform at the first voltage to an output waveform at a second voltage; a rectifier circuit coupled receive the output waveform and produce a direct current (DC) rail voltage; and a comparator circuit coupled to receive the DC rail voltage and to compare the DC rail voltage with a reference voltage and generate a feedback signal to be communicated to the power transmitter.

In some aspects, the techniques described herein relate to an apparatus, wherein the power transmitter is configured to adjust the first voltage of the power waveform responsive to the feedback signal so as to maintain the DC rail voltage at a desired level.

In some aspects, the techniques described herein relate to an apparatus, wherein the comparator circuit is configured to generate the feedback signal so as to cause the power transmitter to decrease the first voltage when the DC rail voltage is greater than the reference voltage and to increase the first voltage when the DC rail voltage is less than the reference voltage.

In some aspects, the techniques described herein relate to an apparatus, wherein the feedback signal is a periodic feedback waveform having a frequency that depends on whether the DC rail voltage is substantially equal to the reference voltage, greater than the reference voltage or less than the reference voltage.

In some aspects, the techniques described herein relate to an apparatus, further including a housing configured to contain the rail voltage converter, wherein the housing is configured to mount to an integrated circuit package or to a circuit board on which the integrated circuit package is attached.

In some aspects, the techniques described herein relate to an apparatus, wherein the housing containing the transformer and the rectifier circuit is configured to attach to a bottom side of the circuit board under the integrated circuit package to provide power to the integrated circuit package.

In some aspects, the techniques described herein relate to a method including: generating, with a power transmitter, a power waveform at a first voltage, the power waveform including a series of successive on-times that are separated by an off-time; receiving the power waveform, via a wire pair, at a transformer; converting, with the transformer, the power waveform at the first voltage to an output waveform at a second voltage; and rectifying the output waveform to produce a direct current (DC) rail voltage for use by one or more power consuming devices.

In some aspects, the techniques described herein relate to a method, further including: comparing the DC rail voltage with a reference voltage; and generating a feedback signal based on the comparing, the feedback signal being communicated to the power transmitter to cause the power transmitter to adjust the first voltage of the power waveform responsive to the feedback signal so as to maintain the DC rail voltage at a desired level.

In some aspects, the techniques described herein relate to a method, wherein generating the feedback signal causes the power transmitter to decrease the first voltage when the DC rail voltage is greater than the reference voltage and to increase the first voltage when the DC rail voltage is less than the reference voltage.

In some aspects, the techniques described herein relate to a method, wherein the feedback signal is a periodic feedback waveform having a frequency that depends on whether the DC rail voltage is substantially equal to the reference voltage, greater than the reference voltage or less than the reference voltage.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)' nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure are described with more particular reference to the accompanying figures above.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

What is claimed is:

1. An apparatus comprising:
a power transmitter configured to generate a power waveform at a first voltage, the power waveform including a series of successive on-times that are separated by an off-time;
a transformer coupled to the power transmitter, wherein the transformer is configured to receive the power waveform and perform a single step down conversion of the power waveform at the first voltage to an output waveform at a second voltage; and
a rectifier circuit coupled to the transformer to receive the output waveform and produce a direct current (DC) rail voltage for use by one or more power consuming devices.

2. The apparatus of claim 1, wherein the first voltage is in a range of 350 volts to 400 volts, and the DC rail voltage is in a range of 0.60 volts to 1.8 volts.

3. The apparatus of claim 1, further comprising a wire pair that connects an output of the power transmitter to a primary winding of the transformer.

4. The apparatus of claim 3, further comprising a comparator circuit that compares the DC rail voltage with a reference voltage and generates a feedback signal to be communicated to the power transmitter, wherein the power transmitter is configured to adjust the first voltage of the power waveform responsive to the feedback signal so as to maintain the DC rail voltage at a desired level.

5. The apparatus of claim 4, wherein the comparator circuit is configured to generate the feedback signal so as to cause the power transmitter to decrease the first voltage when the DC rail voltage is greater than the reference voltage and to increase the first voltage when the DC rail voltage is less than the reference voltage.

6. The apparatus of claim 5, wherein the feedback signal is a periodic feedback waveform having a frequency that depends on whether the DC rail voltage is substantially equal to the reference voltage, greater than the reference voltage or less than the reference voltage.

7. The apparatus of claim 6, wherein the periodic feedback waveform is at a first frequency when the DC rail voltage is substantially equal to the reference voltage, the periodic feedback waveform is at the first frequency plus an incremental frequency amount when the DC rail voltage is less than the reference voltage, and the periodic feedback waveform is at the first frequency less an incremental frequency amount when the DC rail voltage is greater than the reference voltage.

8. The apparatus of claim 6, wherein the comparator circuit is in is configured to couple the periodic feedback waveform to the power transmitter.

9. The apparatus of claim 3, further comprising a housing configured to contain the transformer and the rectifier circuit, wherein the housing is configured to mount to an integrated circuit package or to a circuit board on which the integrated circuit package is attached.

10. The apparatus of claim 9, wherein the housing containing the transformer and the rectifier circuit is configured to attach to a bottom side of the circuit board under the integrated circuit package to provide power to the integrated circuit package.

11. The apparatus of claim 9, wherein the integrated circuit package or circuit board to which the integrated circuit package is attached is mounted in a first layer of an electrical device that comprises a plurality of layers, and wherein the power transmitter is in a second layer of the electrical device.

12. The apparatus of claim 1, wherein the transformer is a multi-monument transformer comprising a primary winding around a first monument, the primary winding configured to receive as input the power waveform, and a first secondary winding around a second monument, the first secondary winding configured to output a first output waveform at the second voltage.

13. The apparatus of claim 12, wherein the transformer further includes a second secondary winding around a third monument, the second secondary winding configured to output a second output waveform at a third voltage.

14. The apparatus of claim 12, wherein the primary winding and/or the first secondary winding comprise a conductive material with one or more layers of graphene.

15. The apparatus of claim 1, wherein the transformer comprises a single monument, a primary winding wrapped around the single monument and configured to receive as input the power waveform, and a secondary winding wrapped around the primary winding and configured to provide the output waveform at the second voltage.

16. An apparatus comprising:
a power transmitter configured to generate a power waveform at a first voltage, the power waveform including a series of successive on-times that are separated by an off-time;
a wire pair having a first end and a second end, the first end coupled to the power transmitter to receive the power waveform; and
a rail voltage converter coupled to the second end of the wire pair, the rail voltage converter comprising:
a transformer configured to receive the power waveform and perform a step down conversion of the power waveform at the first voltage to an output waveform at a second voltage;
a rectifier circuit coupled receive the output waveform and produce a direct current (DC) rail voltage; and
a comparator circuit coupled to receive the DC rail voltage and to compare the DC rail voltage with a reference voltage and generate a feedback signal to be communicated to the power transmitter.

17. The apparatus of claim 16, wherein the power transmitter is configured to adjust the first voltage of the power waveform responsive to the feedback signal so as to maintain the DC rail voltage at a desired level.

18. The apparatus of claim 17, wherein the comparator circuit is configured to generate the feedback signal so as to cause the power transmitter to decrease the first voltage when the DC rail voltage is greater than the reference voltage and to increase the first voltage when the DC rail voltage is less than the reference voltage.

19. The apparatus of claim 18, wherein the feedback signal is a periodic feedback waveform having a frequency that depends on whether the DC rail voltage is substantially equal to the reference voltage, greater than the reference voltage or less than the reference voltage.

20. The apparatus of claim 16, further comprising a housing configured to contain the rail voltage converter, wherein the housing is configured to mount to an integrated circuit package or to a circuit board on which the integrated circuit package is attached.

21. The apparatus of claim 20, wherein the housing containing the transformer and the rectifier circuit is configured to attach to a bottom side of the circuit board under the integrated circuit package to provide power to the integrated circuit package.

22. A method comprising:
generating, with a power transmitter, a power waveform at a first voltage, the power waveform including a series of successive on-times that are separated by an off-time;
receiving the power waveform, via a wire pair, at a transformer;
converting, with the transformer, the power waveform at the first voltage to an output waveform at a second voltage; and
rectifying the output waveform to produce a direct current (DC) rail voltage for use by one or more power consuming devices.

23. The method of claim 22, further comprising:
comparing the DC rail voltage with a reference voltage; and
generating a feedback signal based on the comparing, the feedback signal being communicated to the power transmitter to cause the power transmitter to adjust the first voltage of the power waveform responsive to the feedback signal so as to maintain the DC rail voltage at a desired level.

24. The method of claim 23, wherein generating the feedback signal causes the power transmitter to decrease the first voltage when the DC rail voltage is greater than the reference voltage and to increase the first voltage when the DC rail voltage is less than the reference voltage.

25. The method of claim 24, wherein the feedback signal is a periodic feedback waveform having a frequency that depends on whether the DC rail voltage is substantially equal to the reference voltage, greater than the reference voltage or less than the reference voltage.
